(19) United States
(12) Patent Application Publication
(10) Pub. No.: US 2007/0156321 A1
(43) Pub. Date: Jul. 5, 2007

(54) Speed regulation system for vehicles

(76) Inventor: Jahan N. Schad, Moraga, CA (US)

Correspondence Address: Jahan Schad, 376 Tharp Drive, Moraga, CA, 94556, US

(21) Appl. No.: 11/321,778

(22) Filed: Dec. 29, 2005

(51) Int. Cl. B60T 7/12

(52) U.S. Cl. 701/96

(57) ABSTRACT

This invention provides for a Speed Regulation System, at the disposal of the a vehicle operator, wherein an in-steering wheel apparatus and/or a ten-key pad remote control, and an electronic interface is deployed, that can be used for utilizing the vehicle's existing speed limit control system for additional control, an often needed restraint of the vehicle's factory preset maximum speed allowance, at operator-desired values limit. In this invention, a versatile in-steering wheel apparatus and/or a ten-key pad would enable provision of these other speed limit data, and needed commands, which would activate the vehicle's speed limit control system in order to override any acceleration above the desired speed values. Obviously, the original factory implemented predetermined country speed limit would be kept intact and no temporary selected speed value can exceed this limit

### FIELD OF THE INVENTION

The present invention relates to the existing speed limit control systems of vehicles that are used to automatically limit the maximum driving speed to the factory preset international or country regulation speed of the vehicles, and in particular it relates to a Speed Regulation System for vehicles which is activated by a ten-key pad remote control or alternatively by a two step click action of an implement, such as an electromechanical lever in the steering wheel, for limiting speed at a selective maximum setting in the ranges of speed below the afore-mentioned factory preset speed limits.

### BACKGROUND OF THE INVENTION

Speed control systems for vehicles have been provided in prior art and a few have been in use for quite some time. The purpose of such systems has been to allow automatic operation of vehicles at a certain operator selected speed, or to restrict the vehicle's manual operation below either a factory/regulation set maximum speed limit or, within an owner/operator selected speed range. The well-known Cruise Control system is example of the first category where, through its deployment, the vehicle speed is automatically kept constant at a certain operator-desired value. The example in the second category is the in-engine speed limit control system, in today's vehicles, based on likes of the invention by Park, U.S. Pat. No. 6,094,615. The speed limit control system is designed to automatically limit the maximum driving speed, thus permitting manual operation of the vehicle only below the maximum regulation speed limit of the country in which it is located. So far however, no, in-vehicle, owner/operator method for selecting an alternative maximum speed, has been made available in mass produced vehicles.

Today's modern vehicles are all equipped with a speed limit control system where, the maximum speed limit data, are part of burned-in data of a vehicle's speed control system. Presently the only way to modify the speed data of a vehicle is through (under-hood) use of appropriate hardware and software accessing its general electronic control system. Generally, said speed control system and its operations are completely unbeknownst to the vehicle operator.

Prior arts, U.S. Pat. Nos. 2,822,882, 3,878,915, 4,433,746, 6,094,615, 6,128,570, 6,240,773 B1, 6,681,877 B2, and US Applications 20020170762, 20030216852, 20050247497 and 20050257976, have provided various partial or full in-vehicle speed limit control system schemes. However, the familiar Cruise Control system is, so far, the only in-vehicle speed limit control system that is manually operable in today's modern vehicles. The speed limit control systems have nowhere been used for any purpose other than automatically limiting the maximum driving speed to a factory preset value. The reason for the vehicle industries' lack of subscription to the above noted in-vehicle systems, must have been, mainly, severe impracticality, shortcoming, cost and finally their inability to complement the existing under-hood maximum speed limit control systems.

A rather recent modification of the automobile cruise control system has been achieved in U.S. Pat. No. 5,5,775,451 (Hull, et al. 1998), the first of its kind, wherein a combination of a ten-key pad and cruise control system is deployed. This ten-key pad has the added advantage of providing for multiple settings of cruise control, where each setting designates the constant cruise speed of vehicle. Hull's invention, in spite of its advantage of interfacing with an existing Cruise control systems, has not found its way into present day vehicles. Hull's invention, like other in-vehicle speed control systems, suffers from some measure of impracticality. The present invention teaches deployment of an existing under-hood maximum speed limit control systems with a design that utilizes two different activation/engagement methods. In one method, a “cruise control like” apparatus provides a very practical, simple and familiar means to operate the system. The second method relies on a ten-key pad remote control that can provide predetermined and programmed operations.

This invention allows a vehicle operator the selection(s) (secure or otherwise) of maximum speed(s) that the vehicle could not exceed during operation. This novel multifaceted combination, with either a plurality of key pad and/or the “cruise control like” capabilities, provides for a Speed Regulation System that allows both acceleration and deceleration below a chosen maximum limit that is entirely unique.

### SUMMARY OF THE INVENTION

The present invention provides for a Speed Regulation System where a hard-wired ten-key pad remote control and/or an in-steering wheel, “cruise control like’ activation/engagement method is utilized for manual deployment of a vehicle's speed limit control system, from within said vehicle. This system allows for operation of a vehicle below an owner/operator desired speed (still automatically bound by the preset factory speed), thus rendering for the first time, a very useful, practical and novel Speed Regulation System for vehicles. The main advantage points of this invention are:
1) “effective deployment of existing under-hood speed control systems” in today's vehicles, by use of an electronic interface (external or incorporated internally),
2) “hazard avoidance” capability,
3) “cruise control like” implementation,
4) “smooth slow-down” and
5) “use of off-the-shelf electronics” for said interface (in external embodiment case), with no high temperature performance requirements for its components, due to in-panel installation.

The ten-key pad remote controls have been in daily use, in electronic appliances, for a long time, and their design and construct, known in prior art, will not be addressed here. In-steering wheel implementation of the activation/engagement method can be “cruise control like”, where only an ON/OFF, ENTER and RESUME buttons are used, which is also considered obvious.

It is the object of the present invention to deploy the ten-key pad remote control device for either temporary maximum speed selection or secure/non-secure programming of the vehicle speed limit control system, for the enforcement of a desired temporary maximum speed limit during operation of said vehicle. Additionally, it is the object of present invention to deploy a “cruise control like” apparatus, as an alternative method, to enforce a temporary maximum speed limit during operation of said vehicle. The vehicle operator can manually drive at any speed below the selected limit. A cancel button, in said ten-key system, or said OFF button, in said in-steering wheel implementation, provides for overriding said chosen limit, thus returning the vehicle to full factory allowed speed range operation. Canceling the securely selected speed limit would require a password.

It is the further object of this invention to enable selection of any speed value above which the operator does not wish the vehicle to operate. This would eliminate the need to take ones eyes off the road in order to check the speedometer, and can prevent exceeding the road regulation speed, while manually operating a vehicle.

It is another object of this invention, in case often-key pad remote control implementation of the invention, to allow the owner to perform secure programming of the maximum operation speed of the vehicle for city or highway driving by a minor dependent or guest driver.

### BRIEF DESCRIPTION OF THE DRAWINGS

FIG. 1, is the schematic view of the ten-key wired remote control pad, present invention, where it is attached to a dashboard. FIG. 2, schematically depicts the overall block layout plan of the invention.

FIG. 3, is schematic depiction of the major functional elements in the invention. FIG. 4, schematically demonstrates in-steering wheel implementation of the invention, using an example of an electromechanical lever, likes of which are used in some cruise control methods, in a vehicle.

### DETAILED DESCRIPTION OF THE EMBODIMENTS

A complete understanding of the present invention may be obtained by reference to the accompanying drawings.

FIG. 2 is a sketch of the Speed Regulation System of present invention which includes an exemplary ten-key pad remote control (5), connected, through an electronic interface (15), to a speed limit control system (16). The hardware needed for the present invention is of familiar electronic design and engineering construction. Today's I(input)/O(output) electronic boards, with microprocessor and embedded memory—such as Zeno product family of the ZILOG company—offering high level programming capability and, a ten-key pad with Liquid Crystal (LC) display, provide what is needed. Therefore, complete design and engineering of ten key remote control device (5) and said interface (15), known in today's art, will not be discussed. However, the major functional features of said the Speed Regulation System, the subject of this invention, are discussed next.

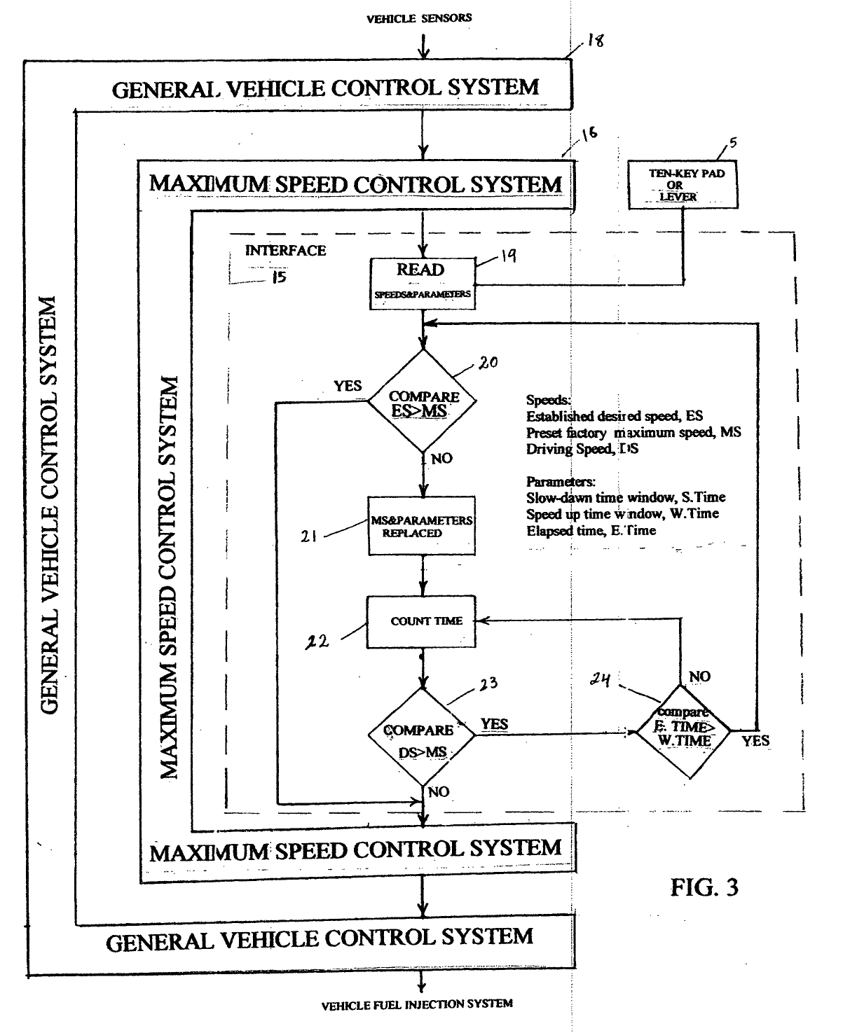

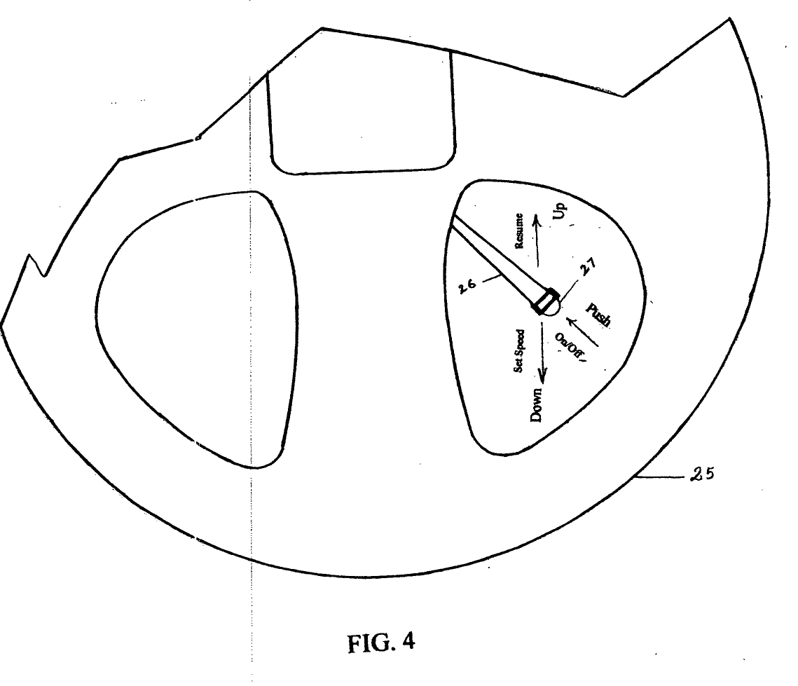

FIG. 3 shows the functional lay-out of this invention, in a general implementation. The prescribing block presentations of vehicles' General Control and the Maximum Speed Control Systems, in the Figure, emphasizes integration of this invention into such existing systems. Driving speed, ignition timing and throttle position of a vehicle are the data that today's speed limit control systems (16), receives from a vehicle's general Control system (18). Prior art such as, U.S. Pat. No. 6,094,615 (hereinafter Park '615), details how these data are used in the design of the maximum speed limit control system (16) and its operation will not be addressed here but is nonetheless hereby incorporated by reference. Said interface of present invention is placed in-line between the memory module of a maximum speed limit control system aid its microprocessor. Those skilled in the art will recognize that said control systems such as Park '615 may implement novel new subject matter like the embodiments disclosed herein either internally or externally, with respect to the general processor and/or novel, speed processor. In an external embodiment, a read module (19) gets the vehicle's preset maximum speed, smooth slow-down (jerky movement prevention) and speed-up parameters from the speed control system memory, as well as, owner/operator established desired maximum speed, smooth slow-down time window and a speed-up duration time window, both very brief periods in the range of 1-30 seconds. The time windows are secure data that only vehicle operator can input.

In an internal, embedded design, the entire novel speed control functions and features described herein may be designed into a printed circuit card or hybrid power general processor circuit card. In such an embodiment, the entire inputs and outputs of said novel speed control features will be connected via the etching and circuitry of the general processor circuit card.

Another embodiment is the case of an in-steering wheel embodiment of the system, only maximum speed is needed and factory default data are used for other data needs. Module (20) compares the established temporary maximum speed with the factory preset maximum speed (or earlier created temporary secondary maximum speed), and if the former is less than the latter, a temporary secondary maximum speed, equal to the established speed is created in step (21). At this point the secondary owner/operator time window data are also accepted. A timer, in step (22) is also activated simultaneously. These data

serve to keep smooth manual operation of a vehicle below the desired speed. Steps (23) and (24) are designed to allow speed-up for an elapsed time not exceeding the earlier established time window. Slow-down time data are used in the speed control system.

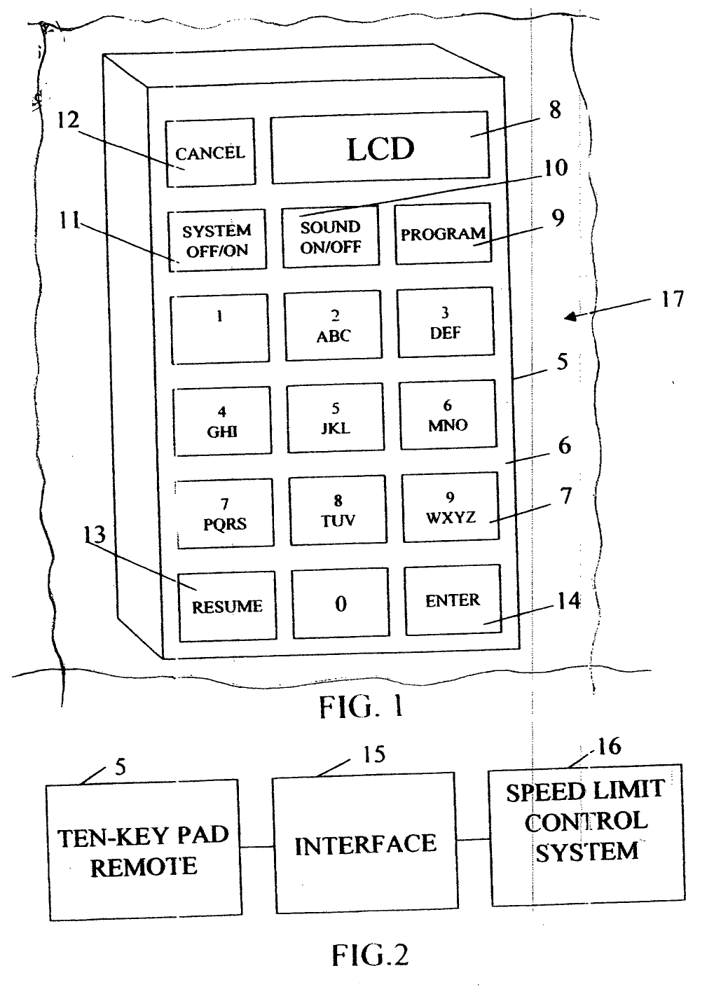

The detail drawing of the ten-key pad remote control (5), in FIG. 1, shows the control pad (6), which is deployed for data and command input to the vehicle speed limit control system (16). The control pad includes customary Alpha-Numeric buttons (7) of engineering choice, a Liquid Crystal Display (LCD) (8), a Program button (9), a Cancel button (12), a System ON/OFF button (11), a Sound ON/OFF button (10), an Enter button and a Resume button (13).

The ten-key remote control (5) as shown in FIG. 1, mounted on the dashboard (17), is an exemplary of an after-market installation. It is at an easily accessible location to the driver and is of such construct that is visible to the driver.

Mounting of the ten-key remote control can be done with various known and available choices, such as Velcro strips, not shown here. The electronic interface (16), hard wired to said ten-key remote control (5) and said seed control system will be hidden behind front panel of a vehicle. Keeping the electronics of the interface (16) outside of the engine environment, removes the stringent requirements high temperature performance from its chips.

The ten-key remote control (5) can be built and/or accessed variedly in other embodiments. It can also be incorporated in the vehicle dashboard at the point of manufacture.

Referring to FIG. 1, the ten-key pad operation of the Speed Regulation System, part of the subject of this invention, is as follows:

Maximum speed selection is made, after turning the system on by depressing button ON/OFF button (11), through the Alpha-Numeric pad keys (7), displayed on the LCD (8), followed by pressing the Enter button (14). Pressing the ENTER button (14) right after turning the system on during operation provides the present driving speed of the vehicle as default value for the maximum speed. The vehicle speed limit control system would now allow operation of the vehicle up to and including the selected speed, and any sustained attempted acceleration beyond it would be ineffective, unless Cancel button (12) or ON/OFF is depressed. Button (13) is used to resume the cancelled speed limit. For selection of a secure maximum speed, the Program Button (9) is depressed upon which on screen selections (on LCD) provide options for a), secure programming of speed data (speed limit, overtake episode and other specific parameters specific to the speed limit control system) and b), non-secure pre-programming of a number of speed limit settings. For secure programming a four key password entry is required first, followed by entry of the desired maximum speed limit and speed parameters, if system defaults are not accepted. For option b, any of the keys, preferably “1” key, from the pad (6) is depressed followed by depressing of the program key (9) and subsequent selection of a speed limit and depressing of the Enter key (14). This can be repeated for other pre-program settings using key “2”, and so on. Activation of the non-secure pre-programmed speed limits only requires depressing the program key (9) followed by the depression of the corresponding pre-set speed key and the Enter key (14), in sequence. Cancellation of a secure programmed speed data would require the input of the password after depressing of the cancel key (12). First time selected password would remain intact unless changed by the owner of the vehicle. The sound button (10) provides an option to alert the driver when nearing the selected speed limit. The System button (11) is used for engagement or disengagement of the ten-key pad remote control (5). LCD (liquid crystal display) (8) will indicate the system status.

The default maximum speed selection option, explained earlier in above paragraph [022], provides for deployment of the Speed Regulation System of this invention in a manner similar to constant speed selection in a Cruise Control System. Implementation of only ON/OFF, ENTER and RESUME buttons, in the steering wheel (25), creates a very easy and practical method for a “cruise control like” use of the Speed Regulation System in the operation of a vehicle, as shown in FIG. 4. An electromechanical push button (27) at the end of an electromechanical lever (26) would represent ON/OFF button. Down position of the lever (26), selects the driving speed as the desired maximum speed while, upward push of the lever resumes a priority cancelled maximum speed, as the desired maximum speed.

Neither selection of speed limits, secure or otherwise, can exceed the factory preset maximum vehicle speed limit, as discussed earlier.

With either and any of the selected speed limits, be it secure or otherwise, the vehicle can be accelerated above the chosen limits, for a short factory preset default episode, or a secondary owner chosen time, in the range of 1-30 second, when said Speed Regulation System is engaged, in order to allow overtakes or avoidance of hazardous situations. The episode for acceleration, exceeding an operator selected maximum, is a secure programmed value entered by the ten-key pad remote control. As discussed in item [022] above, depression of the program button (9), and subsequent owner password insertion, would allow such secure option, where the specific speed limit control system data can be chosen.

This invention provides for a speed regulation system, at the disposal of the vehicle operator, wherein a ten-key pad remote control, or an in-steering wheel apparatus, is deployed for utilizing the vehicle speed limit control system for additional control of the vehicle maximum speed at operator-desired values. In this invention, in its complete implementation, a versatile ten-key pad would enable provision of these other speed limit data, and commands, which would activate the vehicle speed limit control system to override any acceleration above the desired speed values. Obviously, the original factory implemented predetermined country speed limit would be kept intact and no temporary selected speed value can exceed this limit.

Therefore, it is the object of this invention to introduce two very important and useful applications in vehicle operation:
1) The present invention enables the operator to set the maximum temporary speed of the vehicle equal to the speed, normally posted on the road sign, thus avoiding inadvertent exceeding of such speeds, without taking ones eyes off the road. This helps avoid possible endangerment of pedestrians and vehicular accidents, as well as avoiding expensive traffic tickets. Furthermore, its “cruise control like” implementation makes its use very appealing for today's drivers, thus making its use wide spread.
2) A secure and programmable part of the invention can be deployed to prevent minor dependent drivers from operation of the vehicle above the highway speed limits. This facility would be at the disposal of the adult owner of the vehicle.

It is to be noted that while this invention has been described in connection with what is presently considered to be the practical embodiments, it is not limited to the disclosures here, but also is intended to include other modifications and enhancements within the scope of the applications and the claims.

1-3. (canceled)

4. A method of speed regulation in-vehicle vehicles comprising the following steps in any order:
selecting and establishing one desired maximum temporary speed limits;
pre-programming one or more desired maximum speed limits;
selecting and establishing a temporary operational maximum speed limit by recalling one of the desired maximum speed limits interactively while operating the vehicle; and automatically controlling the ignition timing or fuel supply of said vehicle while the vehicle is operational, wherein a vehicle operator interactively selects and establishes the operational maximum speed limit from one or more desired maximum speed limits and the vehicle is controlled to not exceed the operational maximum speed limit.

5. The method of claim 4 further comprising the steps of:
establishing a time window wherein the operational maximum speed limit may be exceeded, said time window not to exceed a selected period;
operating the vehicle above the operational maximum speed limit during the time window.

6. The method of claim 4 further comprising the steps of:
establishing a time window wherein slow-down (deceleration) would be controlled within said time period.

7. The method of claim 4 further comprising the steps of:
establishing a temporary secure, or otherwise, maximum speed limit while operating the vehicle, said maximum speed limit being lower than a factory preset speed limit and adjustable interactively while the vehicle is in operation, wherein the secure maximum speed limit requires a password to establish.

8. The method of claim 4 further comprising the steps of:
de-establishing (canceling) a temporary maximum speed limit while operating the vehicle, said cancel action returns operation of said vehicle to normal operating conditions wherein speed limit would be limited by any securely established maximum speed or the factory preset speed limit.

9. The method of claim 4 further comprising the steps of:
resuming (re-establishing) a prior canceled established temporary maximum speed

10. The method of claim 4 comprising of;
wherein the speed-up, slow-down times and the secure operational maximum speed limit selections are password controlled.

11. The method of claim 4 wherein the operational maximum speed limit selection is limited by either said secure maximum speed selection or a factory preset maximum speed, whichever is less.

12. The method of claim 4 further comprising the steps of:
providing a microprocessor for controlling the operation of the Speed Regulation System;
customizing a single or multiple selection of maximum speeds and establishing any of such speeds as the desired maximum operation speed of said vehicle;
establishing a secure maximum speed and secure speed-up and smooth slow-down time windows.

13. A Speed Regulation System for vehicles comprising:
a means for engaging said maximum speed regulation system;
a means for selecting a desired maximum speed limit for a vehicle;
a means, for selecting a speed-up and slow-down time windows; and
a means for changing the speed of the vehicle to operate within the maximum speed limit or the preset legal speed limit, wherein the maximum speed regulation system operates during vehicle operation such that the desired maximum speed, speed-up and slow down windows are selected interactively.

14. The system of claim 13 further comprising:
a means for interactively establishing a securely selected maximum speed limit and a securely selected speed-up and slow-down time windows replacing the existing maximum speed limit and default time windows, if said securely selected maximum speed is less than the legal speed limit;
a means for establishing a selected maximum speed as an unsecured temporary maximum speed limit for said vehicle, thus replacing a higher factory preset maximum speed limit;
a means for prohibiting speed-up beyond the securely selected maximum speed limit for periods exceeding said speed-up time window;
a means for disengaging said maximum speed regulation system to allow normal operation of the vehicle subject to said securely selected maximum speed limit or the factory preset speed limit;

15. The system of claim 13 further comprising:
a microprocessor for controlling all of said means;
a display system for operation with the microprocessor for displaying maximum speed limits and an operational state of the Speed Regulation System;
a key pad, with a liquid crystal (LC) display for operation with said microprocessor, wherein the microprocessor, display and key pad provide the means to engage said speed regulation system, select the desired maximum speed limit for the vehicle, select the speed-up and slow-down time windows; and change the speed of the vehicle to operate within the maximum speed limit or the preset legal speed limit.

16. The system of claim 15 wherein the microprocessor, display and key pad further provide the means for preprogrmming a single or multiple maximum speed, engaging or disengaging of the interactive maximum speed regulation system, resumption of operation subject to prior selection conditions, and canceling of any of said means.

17. The system of claim 15 wherein the microprocessor, display and key pa further provide the means for entering a password for providing access to one or more predetermined features of the system.

18. The system of claim 13 further comprising:
a control mechanism mounted on a steering wheel of the vehicle, where said control mechanism provides for the ON/OFF, ENTER and RESUME operations of the interactive speed regulation system, wherein the control mechanism alone can operate the speed regulation system.

19. The system of claim 17 wherein the control mechanism further provides for controlling the speedup and slow-down time windows.
